(19) United States
(12) Patent Application Publication
(10) Pub. No.: US 2025/0045111 A1
(43) Pub. Date: Feb. 6, 2025

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Takeo HOSOMI, Tokyo (JP)

(73) Assignee: NEC Corporation, Tokyo (JP)

(21) Appl. No.: 18/782,331

(22) Filed: Jul. 24, 2024

(30) Foreign Application Priority Data
Aug. 3, 2023 (JP) 2023-127253

(51) Int. Cl. G06F 9/50

(52) U.S. Cl. CPC G06F 9/5027; G06F 9/5072; G06F 2209/509

(57) ABSTRACT

An information processing apparatus includes: an acquisition unit acquires record information from a storage device; and a determination unit determines whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

### CROSS-REFERENCE TO RELATED APPLICATION

This application is based upon and claims the benefit of priority from Japanese patent applications No. 2023-127253, filed on Aug. 3, 2023, the disclosure of which is incorporated herein in its entirety by reference.

### BACKGROUND OF THE INVENTION

### 1. Field of the Invention

The present disclosure relates to an information processing apparatus, an information processing method, and a computer-readable recording medium in which cloud bursting is used

### 2. Background Art

If a server included in a High-Performance Computing (HPC) system is under high load (if load is high), the wait time from the submission of a job to the start of processing may be extended. In view of this, techniques such as cloud bursting are disclosed as techniques for reducing the wait time. In cloud bursting, for example, it is determined whether the job can be executed using an available server included in a cloud that can communicate with the HPC system, and, if so, processing of the job is executed using the available server.

As a related technique, Cited Document 1 (Japanese Patent Laid-Open Publication No. 2021-197039) discloses a burstable instance recommendation apparatus that appropriately recommends burstable instances that are candidate migration destinations of an instance.

In order to reduce the wait time of the server in the HPC system, it would be sufficient to increase the amount of processing executed by the cloud. However, an increase in the amount of processing executed by the cloud would lead to an increase in the cost for using the cloud. That is, there is a trade-off relationship between mean wait time and cost.

Note that techniques such as that disclosed in above-described Cited Document 1 do not improve the trade-off relationship between wait time and cost. Furthermore, such techniques do not improve job wait time within the predetermined cost in a case in which the cost that can be spent to use the cloud during a predetermined period is determined in advance.

### SUMMARY OF THE INVENTION

An example object of the present disclosure is to improve job wait time within the predetermined cost in a case in which the cost during a predetermined period is determined in advance.

In order to achieve the example object described above, an information processing apparatus according to an example aspect includes:
an acquisition unit acquires record information from a storage device; and
a determination unit determines whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

Also, in order to achieve the example object described above, an information processing method that is performed by an information processing apparatus according to an example aspect includes:
acquiring record information from a storage device; and
determining whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

Furthermore, in order to achieve the example object described above, a computer-readable recording medium according to an example aspect includes a program recorded on the computer-readable recording medium, the program including instructions that cause the computer to carry out:
acquiring record information from a storage device; and
determining whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

As described above, according to the present disclosure, job wait time can be improved within the predetermined cost in a case in which the cost during a predetermined period is determined in advance.

### BRIEF DESCRIPTION OF THE DRAWINGS

FIG. 1 is a diagram for describing an example of the configuration of the information processing apparatus in the first example embodiment.

FIG. 2 is a diagram for describing an example of a configuration of a system including the information processing apparatus in the first example embodiment.

FIG. 3 is a diagram for describing an example of the operations of the information processing apparatus in the first example embodiment.

FIG. 4 is a diagram illustrating results for ANL.

FIG. 5 is a diagram illustrating results for KIT.

FIG. 6 is a diagram for describing an example of a configuration of a system including the information processing apparatus in the second example embodiment.

FIG. 7 is a diagram for describing an example of the operations of the information processing apparatus in the second example embodiment.

FIG. 8 is a diagram for describing an example of a computer that realizes the information processing apparatus in the first example embodiment and the second example embodiment.

### EXEMPLARY EMBODIMENT

In the following, an example embodiment will be described with reference to the drawings. Note that, in the drawings described in the following, the same reference symbol is given to elements having the same function or corresponding functions, and repetitive description thereof may be omitted.

### First Example Embodiment

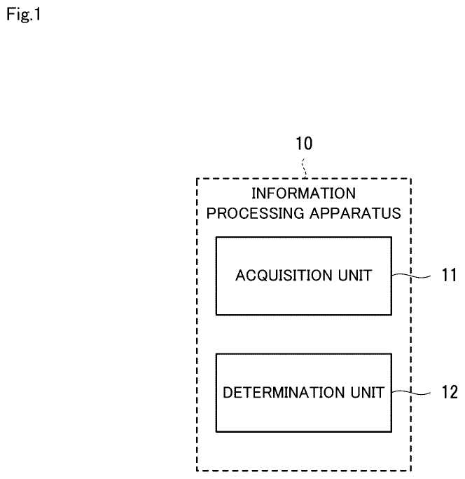

A configuration of an information processing apparatus in a first example embodiment will be described with reference to FIG. 1. FIG. 1 is a diagram for describing an example of the configuration of the information processing apparatus in the first example embodiment.

### [Apparatus Configuration]

In the example in FIG. 1, an information processing apparatus 10 improves the trade-off relationship between mean wait time and cloud cost. Furthermore, in the example in FIG. 1, the information processing apparatus 10 includes an acquisition unit 11 and a determination unit 12.

The acquisition unit 11 acquires record information from a storage device. The determination unit 12 determines whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

The jobs are jobs that have been submitted to the information processing apparatus 10 from a plurality of terminal devices. For example, a job includes information such as a program and data for executing the job using servers and a cloud, the number of servers used to execute the program (required server count), and the amount of time necessary to execute the program (required amount of time). For example, the cost (cloud cost) is the usage fee of the cloud (cloud server).

Because the determination of whether or not a scheduling-target job at a current timepoint is to be offloaded to a cloud is made based on a period during which the cloud is to be used, a maximum value of cumulative cost during the period, an elapsed time, a cumulative value of costs during the elapsed time, and a cost in a case in which the scheduling-target job is executed using the cloud in the example embodiment in such a manner, job wait time can be improved within the predetermined cost in a case in which the cost during a period is determined in advance.

### [System Configuration]

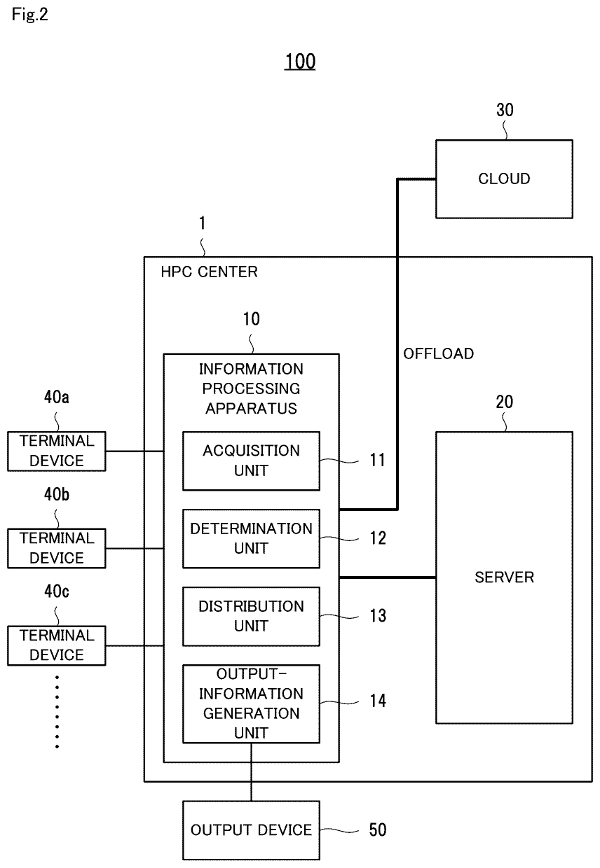

In the example in FIG. 2, the configuration of the information processing apparatus 10 in the first example embodiment will be described in detail. FIG. 2 is a diagram for describing an example of a configuration of a system including the information processing apparatus in the first example embodiment.

In the example in FIG. 2, a system 100 at least includes an HPC center 1, a cloud 30, terminal devices 40 (40a, 40b, 40c, . . . ), and an output device 50. In the example in FIG. 2, the HPC center 1 at least includes the information processing apparatus 10 and a server 20. Note that the information processing apparatus 10, the server 20, the cloud 30, and the terminal devices 40 are connected via a communication network.

For example, the network is a conventional network that is constructed using a communication line such as the Internet, a Local Area Network (LAN), a dedicated line, a telephone line, an enterprise intranet, a mobile communication network, Bluetooth (registered trademark), or Wireless Fidelity (WiFi).

For example, the information processing apparatus 10 is a central processing unit (CPU), a programmable device such as a field-programmable gate array (FPGA), a graphics processing unit (GPU), or an information processing apparatus such as a circuit or a scheduler having one or more of a CPU, a programmable device, and a GPU installed therein.

The server 20 includes one or more servers. Furthermore, for example, each of the servers constituting the server 20 is a CPU, a programmable device such as an FPGA, a GPU, or an information processing apparatus such as a circuit having one or more of a CPU, a programmable device, and a GPU installed therein.

The cloud 30 includes one or more servers. Furthermore, for example, each of the servers constituting the cloud 30 is a CPU, a programmable device such as an FPGA, a GPU, or an information processing apparatus such as a circuit or a server computer having one or more of a CPU, a programmable device, and a GPU installed therein.

Each of the terminal devices 40 (40a, 40b, 40c, . . . ) is an information processing device such as a personal computer or a mobile terminal having installed therein a CPU and/or an FPGA.

The output device 50 acquires the later-described output information, which has been converted into an outputtable format, and outputs image(s), sound, etc., generated based on the output information. For example, the output device 50 is an image display device in which liquid crystal, organic electroluminescence (EL), or a cathode ray tube (CRT) is used, or the like. Furthermore, the image display device may include a sound output device such as a speaker or the like. Note that the output device 50 may be a printing device such as a printer.

The information processing apparatus will be described in detail.

The information processing apparatus 10 includes the acquisition unit 11, the determination unit 12, a distribution unit 13, and an output-information generation unit 14.

The acquisition unit 11 acquires record information from a storage device (not illustrated). The storage device is provided inside the information processing apparatus 10, inside the HPC center 1, or outside the HPC center 1.

The determination unit 12 determines whether or not a scheduling-target job at a current timepoint tc is to be offloaded to a cloud 30 based on a preset period T1 during which the cloud 30 is to be used, a maximum value Cup of cumulative cost that can be spent to use the cloud 30 during the period T1, an elapsed time Tm from a starting timepoint ts of the period T1 to the current timepoint tc, a cumulative value of costs Cv of jobs for which the cloud 30 has been used during the elapsed time Tm, and a cost Cst in a case in which the scheduling-target job is executed using the cloud 30, the period T1, the maximum value Cup, the elapsed time Tm, the cumulative value of costs Cv, and the cost Cst of the scheduling-target job being included in the record information.

Specifically, the determination unit 12 offloads the scheduling-target job at a current timepoint tc to the cloud 30 if a first threshold Th1 (=Cup/T1) that is obtained by dividing the maximum value Cup by the period T1 is greater than a value V (=Ca/Tm) obtained by dividing, by the elapsed time Tm, a value Ca (=Cv+Cst) that is obtained by adding the cost Cst in a case in which the scheduling-target job at the current timepoint is executed using the cloud 30 to the cumulative value of costs Cv (V<Th1).

If the determination unit 12 determines that the scheduling-target job is to be offloaded to the cloud 30, the distribution unit 13 transmits the scheduling-target job to the cloud 30. On the other hand, if the determination unit 12 determines that the scheduling-target job is not to be offloaded to the cloud 30, the distribution unit 13 transmits the scheduling-target job to the server 20.

The output-information generation unit 14 generates output information to be displayed on the output device 50 by combining at least one or more of the period T1 during which the cloud 30 is to be used, the maximum value Cup of cost that can be spent to use the cloud 30 during the period T1, the elapsed time Tm from the starting timepoint ts of the period T1 to the current timepoint tc, the cumulative value of costs Cv of jobs for which the cloud 30 has been used during the elapsed time Tm, the cost Cst in a case in which the scheduling-target job at the current timepoint tc is executed using the cloud 30, information about the scheduling-target job, the result of the determination by the determination unit 12, and time. Then, the output-information generation unit 14 outputs the output information to the output device 50. Note that the output-information generation unit 14 need not be provided in the information processing apparatus 10.

### [Apparatus Operations]

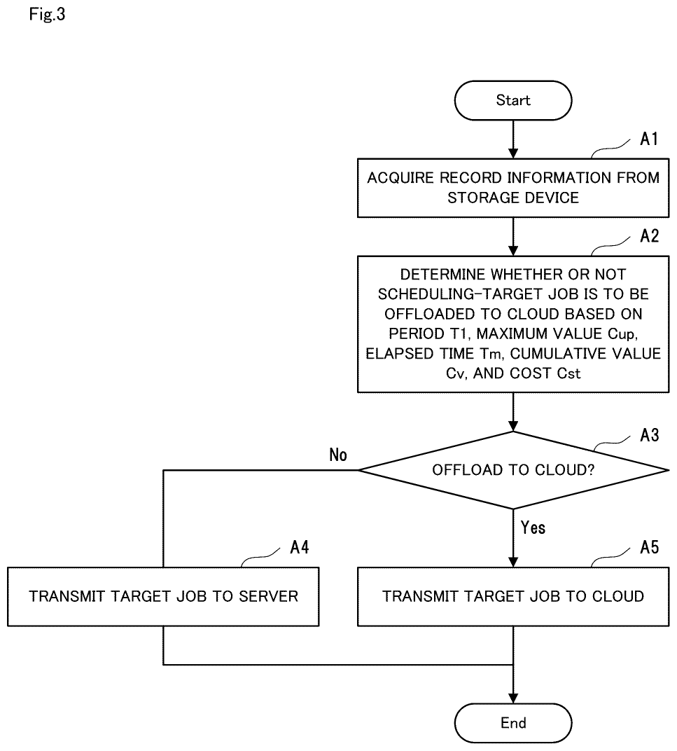

Next, operations of the information processing apparatus in the first example embodiment will be described with reference to FIG. 3. FIG. 3 is a diagram for describing an example of the operations of the information processing apparatus in the first example embodiment. Drawings will be referred to as needed in the following description. Furthermore, in the first example embodiment, an information processing method is implemented by causing the information processing apparatus to operate. Accordingly, the following description of the operations performed by the information processing apparatus is substituted for the description of the information processing method in the first example embodiment.

In the example in FIG. 3, first, the acquisition unit 11 acquires record information from a storage device (not illustrated) (step A1).

Next, the determination unit 12 determines whether or not a scheduling-target job at a current timepoint tc is to be offloaded to a cloud 30 based on a preset period T1 during which the cloud 30 is to be used, a maximum value Cup of cumulative cost that can be spent to use the cloud 30 during the period T1, an elapsed time Tm from a starting timepoint ts of the period T1 to the current timepoint tc, a cumulative value of costs Cv of jobs for which the cloud 30 has been used during the elapsed time Tm, and a cost Cst in a case in which the scheduling-target job is executed using the cloud 30, the period T1, the maximum value Cup, the elapsed time Tm, the cumulative value of costs Cv, and the cost Cst of the scheduling-target job being included in the record information (step A2).

Specifically, in step A2, the determination unit 12 offloads the scheduling-target job at a current timepoint tc to the cloud 30 if a first threshold Th1 (=Cup/T1) that is obtained by dividing the maximum value Cup by the period T1 is greater than a value V (=Ca/Tm) obtained by dividing, by the elapsed time Tm, a value Ca (=Cv+Cst) that is obtained by adding the cost Cst in a case in which the scheduling-target job at the current timepoint is executed using the cloud 30 to the cumulative value of costs Cv (V<Th1).

Next, if the determination unit 12 determines that the scheduling-target job is to be offloaded to the cloud 30 (step A3: Yes), the distribution unit 13 transmits the scheduling-target job to the cloud 30 (step A5). On the other hand, if the determination unit 12 determines that the scheduling-target job is not to be offloaded to the cloud 30 (step A3: No), the distribution unit 13 transmits the scheduling-target job to the server 20 (step A4). In such a manner, the above-described processing from step A1 to step A5 is executed repeatedly.

### [Effects of First Example Embodiment]

Because the determination of whether or not a scheduling-target job at a current timepoint is to be offloaded to a cloud is made based on a period during which the cloud is to be used, a maximum value of cost during the period, an elapsed time, a cumulative value of costs during the elapsed time, and a cost in a case in which the scheduling-target job is executed using the cloud according to the first example embodiment in such a manner, job wait time can be improved within the predetermined cost in a case in which the cost during a period is determined in advance.

In conventional technology, a job is transmitted to the cloud 30 if a preset maximum of the number of servers to be temporarily used in the cloud 30 is equaled or exceeded. Specifically, in conventional technology, a job is transmitted to the cloud 30 if the number of available servers in the cloud 30 is more than or equal to the number of servers required by the job.

That is, the mean wait time can be reduced by increasing the available number of servers in the cloud 30. However, an increase in the number of servers in the cloud 30 that are used would lead to an increase in cost (cloud cost).

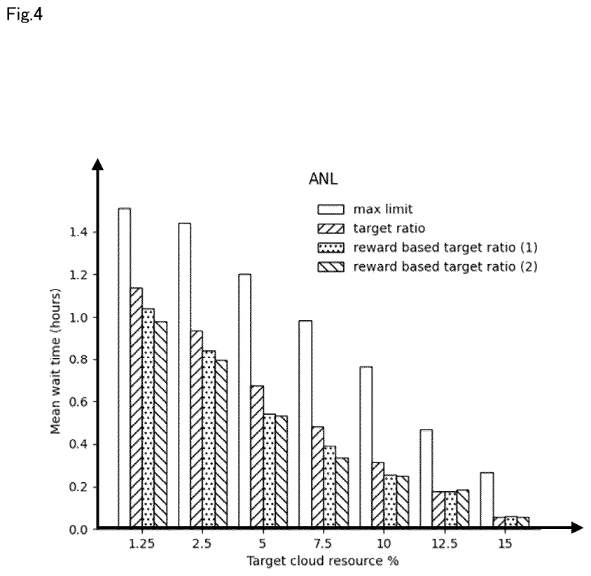

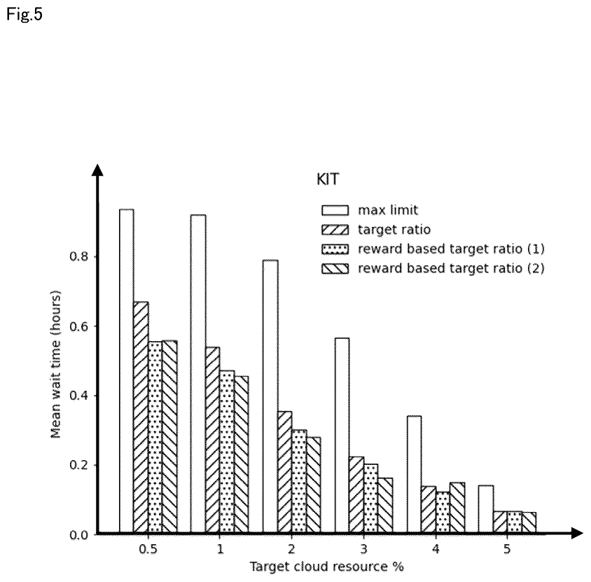

FIG. 4 is a diagram illustrating results for ANL. FIG. 5 is a diagram illustrating results for KIT. For example, the results are those obtained by performing evaluation using typical job workloads. Note that, for the evaluation, the two workloads “The ANL Intrepid log” (hereinafter “ANL”) and “The KIT ForHLR II log” (hereinafter “KIT”) were used among the large number of workloads publicly disclosed in “Logs of Real Parallel Workloads from Production Systems” (<https://www.cs.huji.ac.il/labs/parallel/workload/logs.html>). FIG. 4 illustrates the results of evaluation using ANL. FIG. 5 illustrates the results of evaluation using KIT.

Furthermore, FIG. 4 illustrates an example in which ANL was used as the job workload. The vertical axis in FIG. 4 indicates wait time (Mean wait time (hours)), and the horizontal axis in FIG. 4 indicates a proportion (Target cloud resource (%)) for which the cloud 30 was available for use with respect to 100% indicating the on-premises resource amount (number of servers×period).

The bars labeled “Max limit” in FIG. 4 indicate conventional technology in which the determination of whether or not a scheduling-target job at a current timepoint is to be offloaded to the cloud 30 is made based on the preset maximum value Cup of cumulative cost that can be spent to use the cloud 30, the cumulative value of costs Cv of jobs for which the cloud 30 has been used until the current timepoint, and the cost Cst in a case in which the scheduling-target job is executed using the cloud 30.

Specifically, the scheduling-target job is offloaded to the cloud 30 if the maximum value Cup is greater than a value Ca (=Cv+Cst) that is obtained by adding the cost Cst in a case in which the scheduling-target job at the current timepoint is executed using the cloud 30 to the cumulative value of costs Cv (Ca<Cup).

Furthermore, the bars labeled “target ratio” in FIG. 4 indicate a case in which the first example embodiment is applied. Specifically, it can be seen that, by applying the technique according to the first example embodiment, job wait time is improved within the predetermined cost in a case in which the cost during a period is determined in advance, as illustrated in the example in FIG. 4.

FIG. 5 illustrates an example in which KIT was used as the job workload. The vertical axis in FIG. 5 indicates wait time (Mean wait time (hours)), and the horizontal axis in FIG. 4 indicates a proportion (Target cloud resource (%)) for which the cloud 30 was available for use with respect to 100% indicating the on-premises resource amount (number of servers×period).

The bars labeled “Max limit” in FIG. 5 indicate conventional technology in which the determination of whether or not a scheduling-target job at a current timepoint is to be offloaded to the cloud 30 is made based on the preset maximum value Cup of cumulative cost that can be spent to use the cloud 30, the cumulative value of costs Cv of jobs for which the cloud 30 has been used until the current timepoint, and the cost Cst in a case in which the scheduling-target job is executed using the cloud 30.

Furthermore, the bars labeled “target ratio” in FIG. 5 indicate a case in which the first example embodiment is applied. It can be seen that, also in the example in FIG. 5, job wait time is improved within the predetermined cost in a case in which the cost during a period is determined in advance, as was the case in the example in FIG. 4.

### [Program]

The program according to the first example embodiment may be a program that causes a computer to execute steps A1 to A5 shown in FIG. 3. By installing this program in a computer and executing the program, the information processing apparatus and the information processing method according to the first example embodiment can be realized. In this case, the processor of the computer performs processing to function as the acquisition unit 11, the determination unit 12, a distribution unit 13, and an output-information generation unit 14.

Also, the program according to the embodiment may be executed by a computer system constructed by a plurality of computers. In this case, for example, each computer may function as any of the acquisition unit 11, the determination unit 12, a distribution unit 13, and an output-information generation unit 14.

### Second Example Embodiment

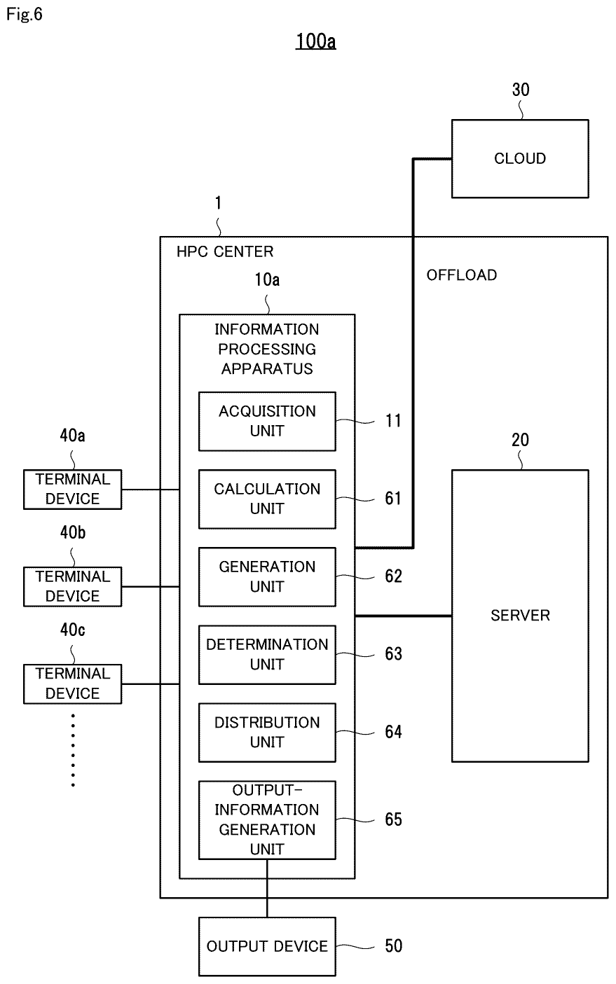

A configuration of an information processing apparatus in a second example embodiment will be described with reference to FIG. 6. FIG. 6 is a diagram for describing an example of a configuration of a system including the information processing apparatus in the second example embodiment.

### [System Configuration]

In the example in FIG. 6, a system 100a at least includes the HPC center 1, the cloud 30, the terminal devices 40 (40a, 40b, 40c, . . . ), and the output device 50. In the example in FIG. 6, the HPC center 1 at least includes an information processing apparatus 10a and the server 20. Note that the information processing apparatus 10a, the server 20, the cloud 30, and the terminal devices 40 are connected via a communication network.

The information processing apparatus will be described in detail.

The information processing apparatus 10a includes the acquisition unit 11, a calculation unit 61, a generation unit 62, a determination unit 63, a distribution unit 64, and an output-information generation unit 65. Note that, because the acquisition unit 11 has already been described in the first example embodiment, description thereof will be omitted.

The calculation unit 61 calculates a cloud appropriateness value using a cost (cloud cost) when the cloud 30 is used for a scheduling-target job and an index indicative of a quantity of all jobs waiting to be scheduled at a current timepoint.

The cloud appropriateness value is information used to improve the trade-off relationship between wait time and cost, and is information for determining whether or not to offload the job to the cloud.

The generation unit 62 generates a second threshold Th2 using the record information. Specifically, the generation unit 62 acquires the cloud appropriateness value and the cost Cst for each of a plurality of jobs that have been scheduled during the elapsed time Tm and that are included in the record information. Next, the generation unit 62 calculates a cumulative value Cv by accumulating the corresponding costs Cst in the order of smaller cloud appropriateness values, and sets, as the second threshold Th2, a value V (=Cv/Tm) that is obtained by dividing the cumulative value Cv by the elapsed time Tm and that is close to the first threshold Th1.

For example, the value closest to the first threshold Th1 may be set as the second threshold Th2, or a value within a preset range including the first threshold Th1 may be set as the second threshold Th2.

The determination unit 63 includes (i) a first determination unit that determines whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

Furthermore, the determination unit 63 includes (ii) a second determination unit that compares the cloud appropriateness value and the second threshold Th2, and, based on a result of the comparison, determines whether or not the scheduling-target job is to be offloaded to the cloud.

Furthermore, in accordance with the decisions made by the first and second determination units, the determination unit 63 determines whether or not the job is to be offloaded to the cloud.

Detailed description will be provided in regard to (i).

The determination unit 63 determines that the scheduling-target job is to be offloaded to the cloud 30 if a first threshold Th1 that is obtained by dividing the maximum value Cup by the period T1 is greater than a value V (=Ca/Tm) obtained by dividing, by the elapsed time Tm, a value Ca (=Cv+Cst) that is obtained by adding the cost Cst in a case in which the scheduling-target job at the current timepoint is executed using the cloud 30 to the cumulative value of costs Cv (V<Th1).

Description will be provided in regard to (ii) with reference to the following examples (1) to (4).

(1) A case will be described in which the cost and the number of all of the jobs that have been submitted and are yet to be allocated (from the timing of submission to the timing of allocation) are used. In a case in which the index is the number Jk of all of the jobs that have been submitted and are yet to be allocated, the calculation unit 61 calculates a cloud appropriateness value Ca1 (=Jk/Cc) by dividing the number Jk of all of the jobs by the cost (cloud cost) Cc of the target of scheduling.

Next, the determination unit 63 determines whether or not the scheduling-target job is to be offloaded to the cloud 30 based on the cloud appropriateness value Ca1 and the second threshold Th2 generated by the generation unit 62.

(2) A case will be described in which the cost and the sum of resource amounts required by all of the jobs that have been submitted and are yet to be allocated are used. In a case in which the index is the sum SRa (=ΣRak (k=1, 2, . . . , n)=Ra1±Ra2+ . . . +Ran, where n is a positive integer) of resource amounts Rak required by all of the jobs that have been submitted and are yet to be allocated, the calculation unit 61 calculates a cloud appropriateness value Ca2 (=SRa/Cc) by dividing the sum SRa of resource amounts required by all of the jobs by the cost (cloud cost) Cc.

For example, a resource amount is a value Ra (=Rsn×Rst) obtained by multiplying the required number of servers (required server count) Rsn and the amount of time necessary to process the requested job (required amount of time) Rst, which are included in a job.

Next, the determination unit 63 determines whether or not the scheduling-target job is to be offloaded to the cloud 30 based on the cloud appropriateness value Ca2 and the second threshold Th2 generated by the generation unit 62.

(3) A case will be described in which the number of all of the jobs that have been submitted and are yet to be allocated, and a resource amount required by the scheduling-target job are used. In a case in which the index is the number Jk of all of the jobs that have been submitted and are yet to be allocated, the calculation unit 61 calculates a cloud appropriateness value Ca3 (=Jk/Rak) by dividing the number Jk of all of the jobs by a resource amount Rak required by the scheduling-target job.

The resource amount Rak is the resource amount required if the scheduling-target job is executed using the cloud 30.

The second determination unit of the determination unit 63 determines whether or not the scheduling-target job is to be offloaded to the cloud 30 based on the cloud appropriateness value Ca3 and the second threshold Th2 generated by the generation unit 62.

(4) A case will be described in which the sum of resource amounts required by all of the jobs, and the resource amount required by the scheduling-target job are used. In a case in which the index is the sum SRa of resource amounts required by all of the jobs, the calculation unit 61 calculates a cloud appropriateness value Ca4 (=SRa/Rak) by dividing the sum SRa of resource amounts required by all of the jobs by the resource amount Rak required by the scheduling-target job.

Next, the determination unit 63 determines whether or not the scheduling-target job is to be offloaded to the cloud 30 based on the cloud appropriateness value Ca4 and the second threshold Th2 generated by the generation unit 62.

If the determination unit 63 determines that the scheduling-target job is to be offloaded to the cloud 30, the distribution unit 64 transmits the scheduling-target job to the cloud 30. On the other hand, if the determination unit 63 determines that the scheduling-target job is not to be offloaded to the cloud 30, the distribution unit 64 transmits the scheduling-target job to the server 20.

The output-information generation unit 65 generates output information to be displayed on the output device 50 by combining at least one or more of the number of all of the jobs, the sum of resource amounts required by all of the jobs, the cost, the resource amount required by the scheduling-target job, the cloud appropriateness value, information about the scheduling-target job, the result of the determination by the determination unit 63, and time.

Furthermore, the output-information generation unit 65 generates output information to be displayed on the output device 50 by combining at least one or more of the period T1 during which the cloud 30 is to be used, the maximum value Cup of cost that can be spent to use the cloud 30 during the period T1, the elapsed time Tm from the starting timepoint ts of the period T1 to the current timepoint tc, the cumulative value of costs Cv of jobs for which the cloud 30 has been used during the elapsed time Tm, and the cost Cst in a case in which the scheduling-target job at the current timepoint tc is executed using the cloud 30.

Then, the output-information generation unit 65 outputs the output information to the output device 50. Note that the output-information generation unit 65 need not be provided in the information processing apparatus 10a.

### [Apparatus Operations]

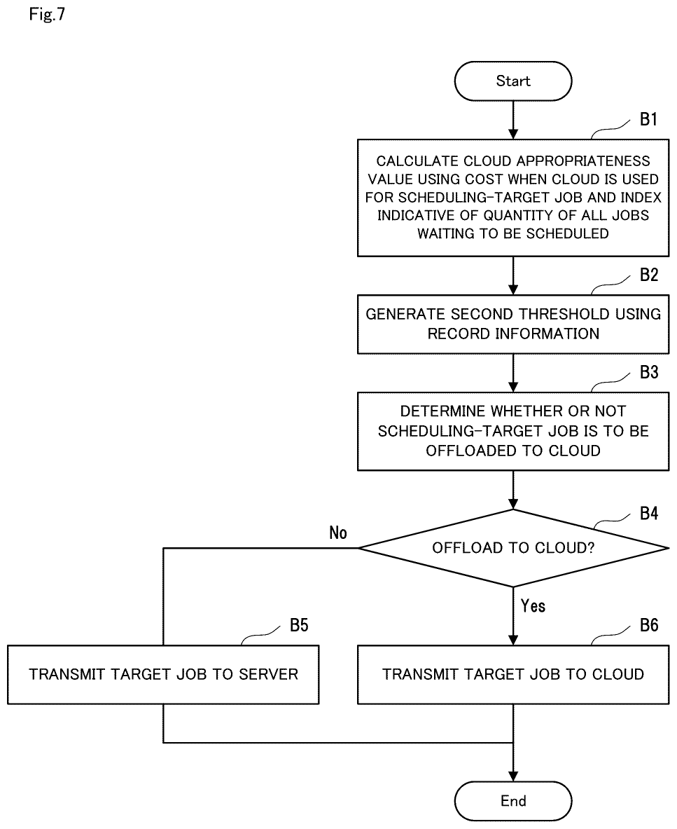

Next, operations of the information processing apparatus in the second example embodiment will be described with reference to FIG. 7. FIG. 7 is a diagram for describing an example of the operations of the information processing apparatus in the second example embodiment. Drawings will be referred to as needed in the following description. Furthermore, in the second example embodiment, an information processing method is implemented by causing the information processing apparatus to operate. Accordingly, the following description of the operations performed by the information processing apparatus is substituted for the description of the information processing method in the second example embodiment.

In the example in FIG. 7, first, the calculation unit 61 calculates a cloud appropriateness value using a cost (cloud cost) when the cloud 30 is used for a scheduling-target job and an index indicative of a quantity of all jobs waiting to be scheduled at a current timepoint (step B1).

Next, the generation unit 62 generates the second threshold Th2 using the record information (step B2). Specifically, in step B2, the generation unit 62 acquires the cloud appropriateness value and the cost Cst for each of a plurality of jobs that have been scheduled during the elapsed time Tm and that are included in the record information. Next, in step B2, the generation unit 62 calculates a cumulative value Cv by accumulating the corresponding costs Cst in the order of smaller cloud appropriateness values, and sets, as the second threshold Th2, a value V (=Ca/Tm) that is obtained by dividing the cumulative value Cv by the elapsed time Tm and that is close to the first threshold Th1.

Next, the determination unit 63 determines whether or not the scheduling-target job is to be offloaded to the cloud 30 (step B3).

Specifically, in step B3, the determination unit 63 (i) determines whether or not a scheduling-target job at a current timepoint is to be offloaded to the cloud 30 based on a preset period during which the cloud 30 is to be used, a maximum value of cumulative cost that can be spent to use the cloud 30 during the period, an elapsed time from a starting timepoint of the period to the current timepoint, a cumulative value of costs of jobs for which the cloud 30 has been used during the elapsed time, and a cost in a case in which the scheduling-target job is executed using the cloud 30, the period, the maximum value, the elapsed time, the cumulative value of costs, and the cost of the scheduling-target job being included in the record information.

Furthermore, in step B3, the determination unit 63 may (ii) compare the cloud appropriateness value and the second threshold Th2, and, based on a result of the comparison, determine whether or not the scheduling-target job is to be offloaded to the cloud 30.

Detailed description will be provided in regard to (i). The determination unit 63 determines that the scheduling-target job is to be offloaded to the cloud 30 if a first threshold Th1 that is obtained by dividing the maximum value Cup by the period T1 is greater than a value V (=Ca/Tm) obtained by dividing, by the elapsed time Tm, a value Ca (=Cv+Cst) that is obtained by adding the cost Cst in a case in which the scheduling-target job at the current timepoint is executed using the cloud 30 to the cumulative value of costs Cv (V<Th1).

Detailed description will be provided in regard to (ii). Description will be provided with reference to the following examples (1) to (4).

(1) A case will be described in which the cost and the number of all of the jobs that have been submitted and are yet to be allocated (from the timing of submission to the timing of allocation) are used. In a case in which the index is the number Jk of all of the jobs that have been submitted and are yet to be allocated, the calculation unit 61 calculates a cloud appropriateness value Ca1 (=Jk/Cc) by dividing the number Jk of all of the jobs by the cost (cloud cost) Cc of the target of scheduling.

Next, the determination unit 63 determines whether or not the scheduling-target job is to be offloaded to the cloud 30 based on the cloud appropriateness value Ca1 and the second threshold Th2 generated by the generation unit 62.

(2) A case will be described in which the cost and the sum of resource amounts required by all of the jobs that have been submitted and are yet to be allocated are used. In a case in which the index is the sum SRa (=ΣRak (k=1, 2, . . . , n)=Ra1+Ra2+ . . . +Ran, where n is a positive integer) of resource amounts Rak required by all of the jobs that have been submitted and are yet to be allocated, the calculation unit 61 calculates a cloud appropriateness value Ca2 (=SRa/Cc) by dividing the sum SRa of resource amounts required by all of the jobs by the cost (cloud cost) Cc.

For example, a resource amount is a value Ra (=Rsn×Rst) obtained by multiplying the required number of servers (required server count) Rsn and the amount of time necessary to process the requested job (required amount of time) Rst, which are included in a job.

Next, the determination unit 63 determines whether or not the scheduling-target job is to be offloaded to the cloud 30 based on the cloud appropriateness value Ca2 and the second threshold Th2 generated by the generation unit 62.

(3) A case will be described in which the number of all of the jobs that have been submitted and are yet to be allocated, and a resource amount required by the scheduling-target job are used. In a case in which the index is the number Jk of all of the jobs that have been submitted and are yet to be allocated, the calculation unit 61 calculates a cloud appropriateness value Ca3 (=Jk/Rak) by dividing the number Jk of all of the jobs by a resource amount Rak required by the scheduling-target job.

The resource amount Rak is the resource amount required if the scheduling-target job is executed using the cloud 30.

Next, the second determination unit of the determination unit 63 determines whether or not the scheduling-target job is to be offloaded to the cloud 30 based on the cloud appropriateness value Ca3 and the second threshold Th2 generated by the generation unit 62.

(4) A case will be described in which the sum of resource amounts required by all of the jobs, and the resource amount required by the scheduling-target job are used. In a case in which the index is the sum SRa of resource amounts required by all of the jobs, the calculation unit 61 calculates a cloud appropriateness value Ca4 (=SRa/Rak) by dividing the sum SRa of resource amounts required by all of the jobs by the resource amount Rak required by the scheduling-target job.

Next, the determination unit 63 determines whether or not the scheduling-target job is to be offloaded to the cloud 30 based on the cloud appropriateness value Ca4 and the second threshold Th2 generated by the generation unit 62.

Next, if the determination unit 63 determines that the scheduling-target job is to be offloaded to the cloud 30 (step B4: Yes), the distribution unit 64 transmits the scheduling-target job to the cloud 30 (step B6). On the other hand, if the determination unit 63 determines that the scheduling-target job is not to be offloaded to the cloud 30 (step B4: No), the distribution unit 64 transmits the scheduling-target job to the server 20 (step B5). In such a manner, the above-described processing from step B1 to step B6 is executed repeatedly.

### [Effects of Second Example Embodiment]

As described above, according to the second example embodiment, job wait time can be improved within the predetermined cost in a case in which the cost within a period is determined in advance because the determination of whether or not a scheduling-target job is to be offloaded to a cloud is performed by further applying (ii) to (i) described above.

Furthermore, the example in FIG. 4 is an example in which ANL was used as the job workload. The bars labeled “reward based target ratio (1)” in FIG. 4 indicate results obtained by applying the number of jobs waiting to be scheduled according to the second example embodiment. Furthermore, the bars labeled “reward based target ratio (2)” in FIG. 4 indicate results obtained by applying the resource amount (required server count×required amount of time) required by all jobs waiting to be scheduled according to the second example embodiment.

In such a manner, it can be seen that, by applying the technique according to the second example embodiment, job wait time is improved within the predetermined cost in a case in which the cost during a period is determined in advance, as illustrated in the example in FIG. 4.

FIG. 5 illustrates an example in which KIT was used as the job workload. In such a manner, it can be seen that, also in the example in FIG. 5, job wait time is improved within the predetermined cost by applying the technique according to the second example embodiment in a case in which the cost during a period is determined in advance, as was the case in the example in FIG. 4.

### [Program]

The program according to the second example embodiment may be a program that causes a computer to execute steps B1 to B6 shown in FIG. 7. By installing this program in a computer and executing the program, the information processing apparatus and the information processing method according to the second example embodiment can be realized. In this case, the processor of the computer performs processing to function as the acquisition unit 11, a calculation unit 61, a generation unit 62, a determination unit 63, a distribution unit 64, and an output-information generation unit 65.

Also, the program according to the embodiment may be executed by a computer system constructed by a plurality of computers. In this case, for example, each computer may function as any of the acquisition unit 11, a calculation unit 61, a generation unit 62, a determination unit 63, a distribution unit 64, and an output-information generation unit 65.

### [Physical Configuration]

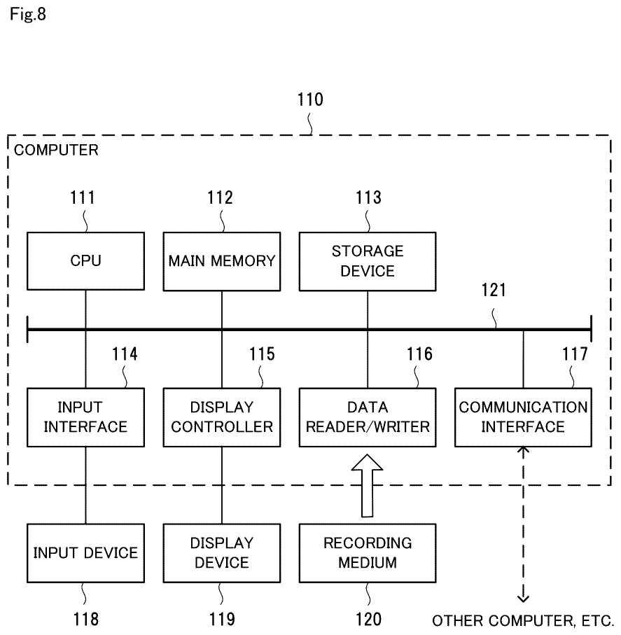

Here, a computer that realizes the information processing apparatus by executing the program according the first example embodiment and second example embodiment will be described with reference to FIG. 8. FIG. 8 is a diagram illustrating an example of a computer that realizes the information processing apparatus in the first example embodiment and second example embodiment.

As shown in FIG. 8, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory).

Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

The information processing apparatus 10 according to the example embodiment can also be achieved using hardware corresponding to the components, instead of a computer in which a program is installed. Furthermore, a part of information processing apparatus 10 may be realized by a program and the remaining part may be realized by hardware. In the example embodiment, the computer is not limited to the computer shown in FIG. 5.

### [Supplementary Note]

The following supplementary notes are also disclosed in relation to the above-described example embodiments. Although at least part or all of the above-described example embodiments can be expressed as, but are not limited to, (Supplementary note 1) to (Supplementary note 24) described below.

### (Supplementary Note 1)

An information processing apparatus comprising:
an acquisition unit that acquires record information from a storage device; and
a determination unit that determines whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

### (Supplementary Note 2)

The information processing apparatus according to supplementary note 1,
wherein the determination unit offloads the scheduling-target job to the cloud if a first threshold that is obtained by dividing the maximum value by the period is greater than a value obtained by dividing, by the elapsed time, a value that is obtained by adding the cost of the scheduling-target job to the cumulative value of costs.

### (Supplementary Note 3)

The information processing apparatus according to supplementary note 2 further comprising:
a calculation unit that calculates a cloud appropriateness value using the cost when the cloud is used for the scheduling-target job and an index indicative of a quantity of all jobs that are waiting to be scheduled at the current timepoint; and
a generation unit that generates a second threshold using the record information,
wherein the determination unit compares the cloud appropriateness value and the second threshold, and, based on a result of the comparison, determines whether or not the scheduling-target job is to be offloaded to the cloud.

### (Supplementary Note 4)

The information processing apparatus according to supplementary note 3,
wherein the generation unit acquires the cloud appropriateness value and the cost for each of a plurality of jobs that have been scheduled during the elapsed time and that are included in the record information, calculates a cumulative value by accumulating the corresponding costs in the order of smaller cloud appropriateness values, and sets, as the second threshold, a value that is obtained by dividing the cumulative value by the elapsed time and that is close to the first threshold.

### (Supplementary Note 5)

The information processing apparatus according to supplementary note 3,
wherein, in a case in which the index is the number of all of the jobs, the calculation unit calculates the cloud appropriateness value by dividing the number of all of the jobs by the cost, and
the determination unit determines whether or not the scheduling-target job is to be offloaded to the cloud based on the cloud appropriateness value and the second threshold.

### (Supplementary Note 6)

The information processing apparatus according to supplementary note 3,
wherein, in a case in which the index is a sum of resource amounts required by all of the jobs, the calculation unit calculates the cloud appropriateness value by dividing the sum of the resource amounts required by all of the jobs by the cost, and
the determination unit determines whether or not the scheduling-target job is to be offloaded to the cloud based on the cloud appropriateness value and the second threshold.

### (Supplementary Note 7)

The information processing apparatus according to supplementary note 3,
wherein, in a case in which the index is the number of all of the jobs, the calculation unit calculates the cloud appropriateness value by dividing the number of all of the jobs by a resource amount required by the scheduling-target job, and
the determination unit determines whether or not the scheduling-target job is to be offloaded to the cloud based on the cloud appropriateness value and the second threshold.

### (Supplementary Note 8)

The information processing apparatus according to supplementary note 3,
wherein, in a case in which the index is a sum of resource amounts required by all of the jobs, the calculation unit calculates the cloud appropriateness value by dividing the sum of the resource amounts required by all of the jobs by a resource amount required by the scheduling-target job, and
the determination unit determines whether or not the scheduling-target job is to be offloaded to the cloud based on the cloud appropriateness value and the second threshold.

### (Supplementary Note 9)

An information processing method that is performed by an information processing apparatus, the method comprising:
acquiring record information from a storage device; and
determining whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

### (Supplementary Note 10)

The information processing method according to supplementary note 9,
wherein the information processing apparatus
   offloading the scheduling-target job to the cloud if a first threshold that is obtained by dividing the maximum value by the period is greater than a value obtained by dividing, by the elapsed time, a value that is obtained by adding the cost of the scheduling-target job to the cumulative value of costs.

### (Supplementary Note 11)

The information processing method according to supplementary note 10,
wherein the information processing apparatus
   calculating a cloud appropriateness value using the cost when the cloud is used for the scheduling-target job and an index indicative of a quantity of all jobs that are waiting to be scheduled at the current timepoint; and
   generating a second threshold using the record information,
   comparing the cloud appropriateness value and the second threshold, and, based on a result of the comparison, determining whether or not the scheduling-target job is to be offloaded to the cloud.

### (Supplementary Note 12)

The information processing method according to supplementary note 11,
wherein the information processing apparatus
   acquiring the cloud appropriateness value and the cost for each of a plurality of jobs that have been scheduled during the elapsed time and that are included in the record information, calculating a cumulative value by accumulating the corresponding costs in the order of smaller cloud appropriateness values, and setting, as the second threshold, a value that is obtained by dividing the cumulative value by the elapsed time and that is close to the first threshold.

### (Supplementary Note 13)

The information processing method according to supplementary note 11,
wherein the information processing apparatus
   in a case in which the index is the number of all of the jobs, calculating the cloud appropriateness value by dividing the number of all of the jobs by the cost, and
   determining whether or not the scheduling-target job is to be offloaded to the cloud based on the cloud appropriateness value and the second threshold.

### (Supplementary Note 14)

The information processing method according to supplementary note 11,
wherein the information processing apparatus
   in a case in which the index is a sum of resource amounts required by all of the jobs, calculating the cloud appropriateness value by dividing the sum of the resource amounts required by all of the jobs by the cost, and
   determining whether or not the scheduling-target job is to be offloaded to the cloud based on the cloud appropriateness value and the second threshold.

### (Supplementary Note 15)

The information processing method according to supplementary note 11,
wherein the information processing apparatus
   in a case in which the index is the number of all of the jobs, calculating the cloud appropriateness value by dividing the number of all of the jobs by a resource amount required by the scheduling-target job, and
   determining whether or not the scheduling-target job is to be offloaded to the cloud based on the cloud appropriateness value and the second threshold.

### (Supplementary Note 16)

The information processing method according to supplementary note 11,
wherein the information processing apparatus
   in a case in which the index is a sum of resource amounts required by all of the jobs, calculating the cloud appropriateness value by dividing the sum of the resource amounts required by all of the jobs by a resource amount required by the scheduling-target job, and
   determining whether or not the scheduling-target job is to be offloaded to the cloud based on the cloud appropriateness value and the second threshold.

### (Supplementary Note 17)

A computer readable recording medium that includes a program recorded thereon, the program including instructions that cause a computer to:
acquiring record information from a storage device; and
determining whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

### (Supplementary Note 18)

The computer readable recording medium according to supplementary note 17,
wherein the program causes the computer to carry out:
   offloading the scheduling-target job to the cloud if a first threshold that is obtained by dividing the maximum value by the period is greater than a value obtained by dividing, by the elapsed time, a value that is obtained by adding the cost of the scheduling-target job to the cumulative value of costs.

### (Supplementary Note 19)

The computer readable recording medium according to supplementary note 18,
wherein the program causes the computer to carry out:
   calculating a cloud appropriateness value using the cost when the cloud is used for the scheduling-target job and an index indicative of a quantity of all jobs that are waiting to be scheduled at the current timepoint; and
   generating a second threshold using the record information,
   comparing the cloud appropriateness value and the second threshold, and, based on a result of the comparison, determining whether or not the scheduling-target job is to be offloaded to the cloud.

### (Supplementary Note 20)

The computer readable recording medium according to supplementary note 19,
wherein the program causes the computer to carry out:
   acquiring the cloud appropriateness value and the cost for each of a plurality of jobs that have been scheduled during the elapsed time and that are included in the record information, calculating a cumulative value by accumulating the corresponding costs in the order of smaller cloud appropriateness values, and setting, as the second threshold, a value that is obtained by dividing the cumulative value by the elapsed time and that is close to the first threshold.

### (Supplementary Note 21)

The computer readable recording medium according to supplementary note 19,
wherein the program causes the computer to carry out:
   in a case in which the index is the number of all of the jobs, calculating the cloud appropriateness value by dividing the number of all of the jobs by the cost, and
   determining whether or not the scheduling-target job is to be offloaded to the cloud based on the cloud appropriateness value and the second threshold.

### (Supplementary Note 22)

The computer readable recording medium according to supplementary note 19,
wherein the program causes the computer to carry out:
   in a case in which the index is a sum of resource amounts required by all of the jobs, calculating the cloud appropriateness value by dividing the sum of the resource amounts required by all of the jobs by the cost, and
   determining whether or not the scheduling-target job is to be offloaded to the cloud based on the cloud appropriateness value and the second threshold.

### (Supplementary Note 23)

The computer readable recording medium according to supplementary note 19,
wherein the program causes the computer to carry out:
   in a case in which the index is the number of all of the jobs, calculating the cloud appropriateness value by dividing the number of all of the jobs by a resource amount required by the scheduling-target job, and
   determining whether or not the scheduling-target job is to be offloaded to the cloud based on the cloud appropriateness value and the second threshold.

### (Supplementary Note 24)

The computer readable recording medium according to supplementary note 19,
wherein the program causes the computer to carry out:
   in a case in which the index is a sum of resource amounts required by all of the jobs, calculating the cloud appropriateness value by dividing the sum of the resource amounts required by all of the jobs by a resource amount required by the scheduling-target job, and
   determining whether or not the scheduling-target job is to be offloaded to the cloud based on the cloud appropriateness value and the second threshold.

Although the invention has been described with reference to the example embodiment, the invention is not limited to the example embodiment described above. Various changes can be made to the configuration and details of the invention that can be understood by a person skilled in the art within the scope of the invention.

### INDUSTRIAL APPLICABILITY

According to the describe above, job wait time can be improved within the predetermined cost in a case in which the cost during a predetermined period is determined in advance. In addition, it is useful in a field where cloud burst is required.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. An information processing apparatus comprising:
at least one memory storing instructions; and
at least one processor configured to execute the instructions to:
acquire record information from a storage device; and
determine whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

2. The information processing apparatus according to claim 1,
wherein the one or more processors further:
offloads the scheduling-target job to the cloud if a first threshold that is obtained by dividing the maximum value by the period is greater than a value obtained by dividing, by the elapsed time, a value that is obtained by adding the cost of the scheduling-target job to the cumulative value of costs.

3. The information processing apparatus according to claim 2 further comprising:
wherein the one or more processors further:
calculates a cloud appropriateness value using the cost when the cloud is used for the scheduling-target job and an index indicative of a quantity of all jobs that are waiting to be scheduled at the current timepoint; and
generates a second threshold using the record information,
compares the cloud appropriateness value and the second threshold, and, based on a result of the comparison, determines whether or not the scheduling-target job is to be offloaded to the cloud.

4. The information processing apparatus according to claim 3,
wherein the generation unit acquires the cloud appropriateness value and the cost for each of a plurality of jobs that have been scheduled during the elapsed time and that are included in the record information, calculates a cumulative value by accumulating the corresponding costs in the order of smaller cloud appropriateness values, and sets, as the second threshold, a value that is obtained by dividing the cumulative value by the elapsed time and that is close to the first threshold.

5. The information processing apparatus according to claim 3,
wherein the one or more processors further:
in a case in which the index is the number of all of the jobs, calculates the cloud appropriateness value by dividing the number of all of the jobs by the cost, and
determines whether or not the scheduling-target job is to be offloaded to the cloud based on the cloud appropriateness value and the second threshold.

6. The information processing apparatus according to claim 3,
wherein the one or more processors further:
in a case in which the index is a sum of resource amounts required by all of the jobs, calculates the cloud appropriateness value by dividing the sum of the resource amounts required by all of the jobs by the cost, and
determines whether or not the scheduling-target job is to be offloaded to the cloud based on the cloud appropriateness value and the second threshold.

7. The information processing apparatus according to claim 3,
wherein the one or more processors further:
in a case in which the index is the number of all of the jobs, calculates the cloud appropriateness value by dividing the number of all of the jobs by a resource amount required by the scheduling-target job, and
determines whether or not the scheduling-target job is to be offloaded to the cloud based on the cloud appropriateness value and the second threshold.

8. The information processing apparatus according to claim 3,
wherein the one or more processors further:
in a case in which the index is a sum of resource amounts required by all of the jobs, calculates the cloud appropriateness value by dividing the sum of the resource amounts required by all of the jobs by a resource amount required by the scheduling-target job, and
determines whether or not the scheduling-target job is to be offloaded to the cloud based on the cloud appropriateness value and the second threshold.

9. An information processing method in which an information processing apparatus executes processing comprising:
acquiring record information from a storage device; and
determining whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.

10. A non-transitory computer readable recording medium that includes a program recorded thereon, the program including instructions that cause a computer to:
acquiring record information from a storage device; and
determining whether or not a scheduling-target job at a current timepoint is to be offloaded to a cloud based on a preset period during which the cloud is to be used, a maximum value of cumulative cost that can be spent to use the cloud during the period, an elapsed time from a starting timepoint of the period to the current timepoint, a cumulative value of costs of jobs for which the cloud has been used during the elapsed time, and a cost in a case in which the scheduling-target job is executed using the cloud, the period, the maximum value, the elapsed time, the cumulative value of costs, and the cost of the scheduling-target job being included in the record information.
